(19) United States
(12) Patent Application Publication
(10) Pub. No.: US 2017/0276537 A1
(43) Pub. Date: Sep. 28, 2017

(54) Method and Terminal for Obtaining Weight of Articles

(71) Applicants: Le Holdings (Beijing) Co., Ltd., Beijing (CN); Lemobile Information Technology (Beijing) Co., Ltd, Beijing (CN)

(72) Inventor: Haosen Suo, Beijing (CN)

(21) Appl. No.: 15/331,252

(22) Filed: Oct. 21, 2016

Related U.S. Application Data
(63) Continuation of application No. PCT/CN2016/096261, filed on Aug. 22, 2016.

(30) Foreign Application Priority Data
Mar. 25, 2016 (CN) 2016101802757

(51) Int. Cl. G01G 3/13; G01L 1/04; G01L 1/16

(52) U.S. Cl. CPC G01G 3/13; G01L 1/16; G01L 1/04; G06F 2203/04105; G06F 3/041

(57) ABSTRACT

Disclosed are a method and terminal for obtaining the weight of articles. The method for obtaining the weight of articles, provided by the embodiments of the present disclosure, includes: obtaining pressure information of an edge touch area of the terminal after an article is hung on the terminal; and obtaining the weight of the article according to the pressure information of the edge touch area of the terminal. The technical scheme provided by the embodiments of the present disclosure solves the problem of the weighing device being inconvenient to carry and a user cannot weigh articles at any time in the prior art. Therefore, the articles can be weighed by only using the terminal, and the efficiency of obtaining the weight of the articles is high.

### CROSS REFERENCE TO RELATED APPLICATIONS

This application is a continuation of International Application No. PCT/CN2016/096261, filed Aug. 22, 2016, and claims priority to Chinese Patent Application No. 2016101802757, filed Mar. 25, 2016, the disclosures of which are hereby incorporated in the entirety by reference.

### TECHNICAL FIELD

The present disclosure relates to the technical field of communications, and in particular relates to a method and terminal for obtaining the weight of articles.

### BACKGROUND

With the development of science and technology and the progress of technology, the use of intelligent terminals is becoming more and more popular. In order to improve the use efficiency and enhance good user experience, most of the existing intelligent terminals adopt touch screens to interact with users.

At present, in addition to the basic communication functions, a terminal also can provide a user with a lot of life-related functions, thereby bringing great convenience to the life of the user. For example, a sports-related application can be installed in the terminal, so that the user can obtain sports conditions such as running distance, training indexes, etc. according to the application.

In the implementation of the present disclosure, the inventor finds that the prior art at least has the following problems: users, in daily life, will use weighing device to weigh articles, and because the weighing device is inconvenient to carry, the users can only weigh articles in a place with weighing device. Therefore, the weight of articles cannot be obtained in time, which results in that the efficiency of obtaining the weight of the articles being low.

### SUMMARY

On that account, the present disclosure provides a method and terminal for obtaining the weight of articles in order to solve the problem that the efficiency of obtaining the weight of articles is low because the weighting device is inconvenient to carry and the weight of the articles cannot be obtained in time in the prior art.

In order to achieve the purpose of the present disclosure mentioned above, from one aspect, the embodiments of the present disclosure provide a method for obtaining the weight of articles, including: obtaining pressure information of an edge touch area of a terminal after an article is hung on the terminal; and obtaining the weight of the article according to the pressure information of the edge touch area of the terminal.

According to the aspect mentioned above and any possible implementation way, an implementation way is further provided, and the edge touch area of the terminal includes the edge touch area of at least one side surface of the terminal.

According to the aspect mentioned above and any possible implementation way, an implementation way is further provided, and a pressure sensor is set in the edge touch area of the terminal.

According to the aspect mentioned above and any possible implementation way, an implementation way is further provided, and obtaining the weight of the article according to the pressure information of the edge touch area of the terminal includes: obtaining the weight of the article according to a conversion relationship between pressure and weight and the pressure information.

According to the aspect mentioned above and any possible implementation way, an implementation way is further provided, and the weight of the article is output.

The embodiments of the present disclosure provide a method for obtaining the weight of articles, pressure information of an edge touch area of the terminal is obtained after an article is hung on the terminal, and the weight of the article is obtained according to the pressure information of the edge touch area of the terminal. Therefore, the method for obtaining the weight of articles, provided by the embodiments of the present disclosure, can make use of the edge touch area of the terminal to realize weighing of articles so as to obtain the weight of the articles in time, have the advantage of high efficiency, be convenient and quick, and improve the efficiency of obtaining the weight of articles, thereby solving the problem that the efficiency of obtaining the weight of articles is low because the weighing device is inconvenient to carry and the weight of the articles cannot be obtained in time in the prior art.

In order to achieve a purpose of the present disclosure mentioned above, in another aspect, the embodiments of the present disclosure provide a terminal including: at least one processor, and a memory in communication connection with the at least one processor, wherein the memory stores instructions that can be executed by the at least one processor, and the instructions are executed by the at least one processor to enable the at least one processor to carry out the following steps: obtaining pressure information of the edge touch area of the terminal after an article is hung on the terminal; and obtaining the weight of the article according to the pressure information of the edge touch area of the terminal.

In order to achieve the purpose of the present disclosure mentioned above, in a further aspect, the embodiments of the present disclosure provide a non-transient computer readable storage medium on which the computer executable instructions are stored, and the computer executable instructions are used for: obtaining the pressure information of the edge touch area of the terminal after an article is hung on the terminal; and obtaining the weight of the article according to the pressure information of the edge touch area of the terminal.

In order to achieve the purpose of the present disclosure mentioned above, in a further aspect, the embodiments of the present disclosure provide a computer program product, the computer program product includes a computer program stored on the non-transient computer readable storage medium, the computer program includes program instructions, and a computer executes the method mentioned by the above aspects when the program instructions are executed by the computer.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of embodiment 1 of the method for obtaining the weight of articles provided by some embodiments of the present disclosure;

FIG. 2 is a flow chart of embodiment 2 of the method for obtaining the weight of articles provided by some embodiments of the present disclosure;

FIG. 3 is a schematic diagram of the first structure of the terminal provided by the embodiments of some present disclosure;

FIG. 4 is a schematic diagram of the second structure of the terminal provided by some embodiments of the present disclosure; and

FIG. 5 is a schematic diagram of the hardware structure of the terminal for executing the method for obtaining the weight of articles provided by some embodiments of the present disclosure.

### DETAILED DESCRIPTION

Hereinafter, the preferred embodiments of the present disclosure are illustrated with reference to the accompanying drawings. It should be appreciated that the preferred embodiments described herein are only used for illustrating and interpreting rather than limiting the present disclosure.

In order to better understand the technical scheme of the present disclosure, the embodiments of the present disclosure are described in detail hereinafter with reference to the accompanying drawings.

It should be clear that the described embodiments are only part, rather than all of the embodiments of the present disclosure. On the basis of the embodiments of the present disclosure, all other embodiments obtained by those skilled in the art without creative efforts are within the protection scope of this application.

The terms used in the embodiments of the present disclosure are merely for the purpose of describing specific embodiments rather than limiting the present disclosure. The singular forms “a”, “said” and “the” used in the embodiments and the attached claims of the present disclosure also aim to include plural forms unless the context clearly expresses other meanings.

Depending on the context, the word “if”, for example, used herein may be interpreted as “at the time of” or “when” or “in response to determination” or “in response to detection”. Similarly, depending on the context, the phrase “if determine” or “if detect (stated conditions or events)” may be interpreted as “when determine” or “in response to determination” or “when detect (stated conditions or events)” or “in response to detection (stated conditions or events)”.

### Embodiment 1

FIG. 1 is a flow chart of embodiment 1 of the method for obtaining the weight of articles provided by the embodiments of the present disclosure, and as shown in FIG. 1, the method for obtaining the weight of articles of the present embodiment may specifically include the following steps.

101: pressure information of the edge touch area of the terminal is obtained after an article is hung on the terminal.

In daily life, a weighing device will be used in some cases, for example, at the time of express delivery, it is desired to know the weight of an article needed to be sent, or at the time of shopping, articles may be selected according to corresponding weights, or the like. It is inconvenient to the life of users that the weighing device usually has a certain volume and is inconvenient to carry. Moreover, some articles are too large in volume to weigh on a terminal screen directly.

Therefore, a method for obtaining the weight of articles by using a terminal is provided in the embodiments of the present disclosure, which not only can improve the good interactive experience with users, but also can solve problems in the life.

It should be noted that the terminal involved in the embodiments of the present disclosure may include, but are not limited to, a personal computer (PC), a personal digital assistant (PDA), a wireless handheld device, a tablet computer, a mobile phone, an MP3 player, an MP4 player and the like, and the terminal has a screen.

In the present embodiment, the weight of the article is obtained by virtue of the edge touch area of the terminal through a specific method as follows: when a user needs to weigh an article, a weighing function in the terminal can be triggered, the article is hung on the edge touch area of the terminal, then the terminal can detect the pressure information of the edge touch area, and correspondingly, there is a certain conversion relationship between the pressure information and the weight, and the terminal can obtain the weight of the article according to the pressure information of the edge touch area of the terminal.

For example, the weighing function of the terminal may be either triggered by opening a weighing application in the terminal, or be opened by virtue of a setup menu of the terminal, which is not specially limited by the embodiments of the present disclosure.

It will be appreciated that, edge touch refers to providing touch input through an edge, a frame or a back surface of the terminal, and tracking flipping, sliding or pressing operations of a finger or an article on the edge of the terminal so as to control the terminal.

The edge touch area of the terminal may be an area that the thumb of a user can reach on a side surface of the terminal when the user naturally holds the terminal, and the side surface of the terminal may include other four side surfaces besides the front surface and the back surface.

The edge touch area in the embodiments of the present disclosure includes an edge touch area of at least one side surface of the terminal, and a pressure sensor is set in the edge touch area of the terminal.

A semiconductor deformation pressure is formed on the surface of a sheet of the pressure sensor after the user hangs the article on the edge touch area of the terminal and the pressure sensor in the edge touch area senses the article; and then the sheet is deformed to generate a piezoelectric impedance effect, the change of the impedance is converted into an electric signal, and the terminal can determine the pressure information of the article in the edge touch area of the terminal after obtaining the electric signal.

102: the weight of the article is obtained according to the pressure information of the edge touch area of the terminal.

Specifically, the weight of the article is obtained according to the conversion relationship between pressure and weight and the pressure information.

Wherein, the pressure information refers to a pressure value detected by the pressure sensor. Because in the process of weighing, when the article is hung on the edge touch area of the terminal, the generated pressure and the gravity of the article are opposite in direction and same in value, that is to say, the pressure value is equal to the gravity value, and then the weight of the article is obtained according to the conversion relationship between the gravity and the weight.

The embodiments of the present disclosure provide a method for obtaining the weight of articles, pressure information of an edge touch area of the terminal is obtained after an article is hung on the terminal, and the weight of the article is obtained according to the pressure information of the edge touch area of the terminal. Therefore, the method for obtaining the weight of articles, provided by the embodiments of the present disclosure, can make use of the edge touch area of the terminal to realize weighing of articles so as to obtain the weight of the articles in time, have the advantage of high efficiency, be convenient and quick, and improve the efficiency of obtaining the weight of articles, thereby solving the problem that the efficiency of obtaining the weight of articles is low because the weighing device is inconvenient to carry and the weight of the articles cannot be obtained in time in the prior art.

### Embodiment 2

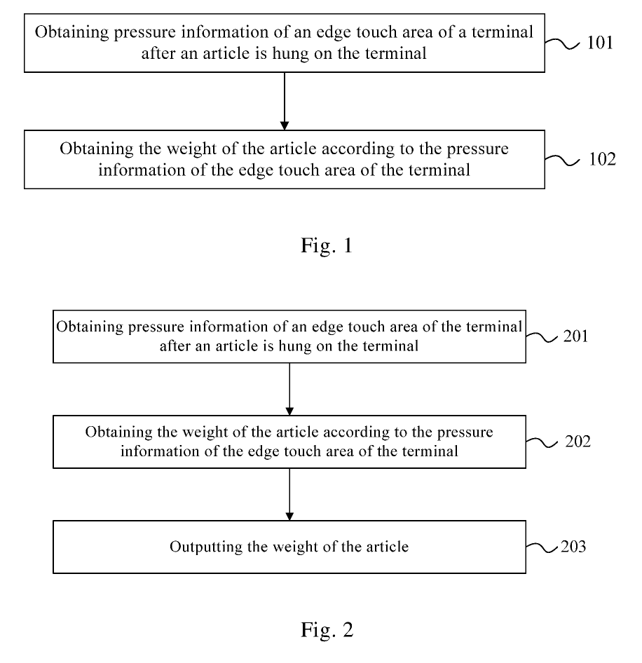

FIG. 2 is a flow chart of embodiment 2 of the method for obtaining the weight of articles provided by the embodiments of the present disclosure, and as shown in FIG. 2, the method for obtaining the weight of articles of the present embodiment may specifically include the following steps.

201: pressure information of the edge touch area of the terminal is obtained after an article is hung on the terminal.

See details in the description of step 101 in the embodiment mentioned above, and the principles and the realization processes in the embodiments of the present disclosure are the same and will not be repeated herein.

202: the weight of the article is obtained according to the pressure information of the edge touch area of the terminal.

See details in the description of step 102 in the embodiment mentioned above, and the principles and the realization processes in the embodiments of the present disclosure are the same and will not be repeated herein.

203: the weight of the article is output.

In the present embodiment, the user can open a weighing function in the terminal and then hang the article on the edge touch area of the terminal; the user can also install an application related to the weighing function, and after the application is opened, the article is hung on the edge touch area of the terminal. The terminal can further output the weight of the article after obtaining the weight of the article. For example, the weight of the article is displayed in a screen of the terminal, or displayed in a page of a weighing application.

The embodiments of the present disclosure provide a method for obtaining the weight of articles, pressure information of an edge touch area of the terminal is obtained after an article is hung on the terminal, and the weight of the article is obtained and output according to the pressure information of the edge touch area of the terminal. Therefore, the method for obtaining the weight of articles, provided by the embodiments of the present disclosure, can make use of the edge touch area of the terminal to realize weighing of articles so as to obtain the weight of the articles in time, have the advantage of high efficiency, be convenient and quick, and improve the efficiency of obtaining the weight of articles, thereby solving the problem that the efficiency of obtaining the weight of articles is low because the weighing device is inconvenient to carry and the weight of the articles cannot be obtained in time in the prior art.

### Embodiment 3

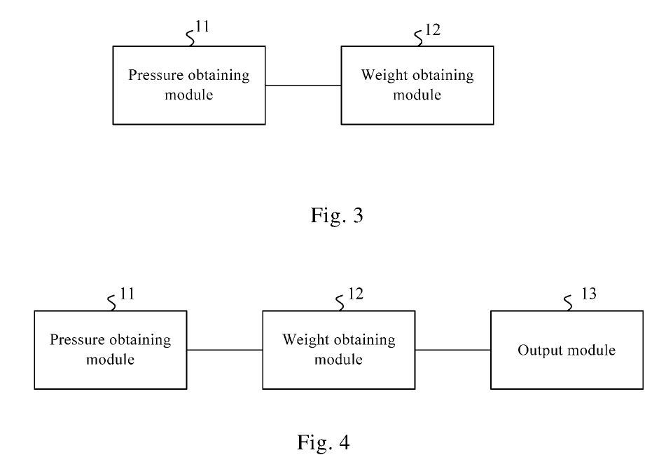

The embodiments of the present disclosure further provide a device embodiment for implementing steps in the method embodiments mentioned above and the method, FIG. 3 is a schematic diagram of the first structure of the terminal provided by the embodiments of the present disclosure, and as shown in FIG. 3, the terminal provided by the embodiments of the present disclosure includes: a pressure obtaining module 11 and a weight obtaining module 12.

The pressure obtaining module 11 is suited for obtaining the pressure information of the edge touch area of the terminal after the article is hung on the terminal.

The weight obtaining module 12 is used for obtaining the weight of the article according to the pressure information of the edge touch area of the terminal obtained by the pressure obtaining module 11.

It should be noted that, the edge touch area of the terminal of the present embodiment includes an edge touch area of at least one side surface of the terminal.

It will be appreciated that a pressure sensor is set in the edge touch area of the terminal provided by the present embodiment.

Wherein, the weight obtaining module 12 is used for obtaining the weight of the article according to the pressure information of the edge touch area of the terminal.

The terminal provided by the embodiments of the present disclosure may be used for executing the technical scheme of the method embodiment shown in FIG. 1, and the realization principle and technical effect are similar to those of the previous embodiments and will not be repeated herein.

By use of the terminal provided by the embodiments of the present disclosure, the pressure information of the edge touch area of the terminal is obtained by the pressure obtaining module 11 after an article is hung on the terminal, and the weight of the article is obtained by the weight obtaining module 12 according to the pressure information of the edge touch area of the terminal. Therefore, the method for obtaining the weight of articles, provided by the embodiments of the present disclosure, can make use of the edge touch area of the terminal to realize weighing of articles so as to obtain the weight of the articles in time, be timely, be convenient and efficient, and improve the efficiency of obtaining the weight of articles, thereby solving the problem that the efficiency of obtaining the weight of articles is low because the weighing device is inconvenient to carry and the weight of the articles cannot be obtained in time in the prior art.

### Embodiment 4

FIG. 4 is a schematic diagram of the second structure of the terminal provided by the embodiments of the present disclosure, and as shown in FIG. 4, the terminal provided by the embodiments of the present disclosure, on the basis of embodiment 3 mentioned above, may also include an output module 13.

The output module 13 is used for outputting the weight of the article.

The terminal of the embodiments of the present disclosure may be used for executing the technical scheme of the method embodiment shown by FIG. 2, and the realization principle and technical effect are similar to those of the previous embodiments and will not be repeated herein.

By use of the terminal provided by the embodiments of the present disclosure, the pressure information of the edge touch area of the terminal is obtained by the pressure obtaining module 11 after an article is hung on the terminal, the weight of the article is obtained by the weight obtaining module 12 according to the pressure information of the edge touch area of the terminal, and finally, the weight of the article is output by the output module 13. Therefore, the method for obtaining the weight of articles, provided by the embodiments of the present disclosure, can make use of the edge touch area of the terminal to realize weighing of articles so as to obtain the weight of the articles in time, be timely, be convenient and efficient, and improve the efficiency of obtaining the weight of articles, thereby solving the problem that the efficiency of obtaining the weight of articles is low because the weighing device is inconvenient to carry and the weight of the articles cannot be obtained in time in the prior art.

### Embodiment 5

The embodiments of this application provide a nonvolatile computer storage medium on which computer executable instructions are stored, and the computer executable instructions may be used for executing a processing method in any method embodiment mentioned above.

### Embodiment 6

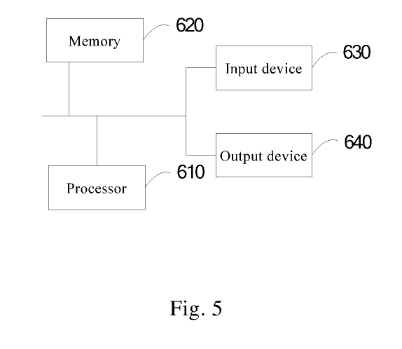

FIG. 5 is a schematic diagram of the hardware structure of the terminal for executing the method for obtaining the weight of articles provided by the embodiments of this application, and as shown in FIG. 5, the terminal includes: one or more processors 610 and a memory 620. FIG. 5 takes one processor 610 as an example. The device may also include: an input device 630 and an output device 640.

The processor 610, the memory 620, the input device 630 and the output device 640 may be connected by virtue of buses or in other ways, and FIG. 5 takes bus connection as an example.

The memory 620 serving as a nonvolatile computer readable storage medium may be used for storing a nonvolatile software program, a nonvolatile computer executable program and modules. The processor 610 runs the nonvolatile software program, the instructions and the modules stored in the memory 620 to execute various function applications and data processing of an electronic device, thereby realizing the processing method of the method embodiments mentioned above.

The memory 620 may include a program storage area and a data storage area, wherein the program storage area may store an operating system and an application needed by at least one function; and the data storage area may store data and the like. In addition, the memory 620 may include a high-speed random access memory, and may also include a nonvolatile memory, for example, at least one disk memory device, a flash memory device, or other nonvolatile solid state memory device. In some embodiments, the memory 620 may be selected from memories remotely set relative to the processor 610, and these remote memories may be connected to a processor through a network. An example of the network mentioned above includes, but is not limited to, Internet, enterprise intranet, local area network, mobile communication network and combinations thereof.

The input device 630 may receive input figure or character information, and generate signal input. The output device 640 may include a display screen and other display devices.

The one or more modules are stored in the memory 620, and when the modules are executed by the one or more processors 610, the following operations are executed: obtaining the pressure information of the edge touch area of the terminal after an article is hung on the terminal; and obtaining the weight of the article according to the pressure information of the edge touch area of the terminal.

In a possible implementation way, the edge touch area of the terminal includes an edge touch area of at least one side surface of the terminal.

In a possible implementation way, a pressure sensor is set in the edge touch area of the terminal.

In a possible implementation way, obtaining the weight of the article according to the pressure information of the edge touch area of the terminal includes: obtaining the weight of the article according to a conversion relationship between pressure and weight and the pressure information.

In a possible implementation way, the weight of the article is output.

The products mentioned above may execute the method provided by the embodiments of this application, and have corresponding functional modules and beneficial effects for executing the method. The technical details not described in detail in the present embodiment may refer to the method provided by the embodiments of this application.

The electronic device of the embodiments of this application exists in various forms, and includes but is not limited to:

Mobile communication device: this type of device has the characteristics of having a mobile communication function, and having a primary target of providing voice and data communication. This type of terminal includes: smart phones (for example iPhone), multimedia mobile phones, functional mobile phones, low-end mobile phones, etc.

Ultra-mobile personal computer device: this type of device is within the scope of personal computers, has computing and processing functions, and generally also has a characteristic of mobile internet access. This type of terminal includes: PDA, MID and UMPC device, etc., for example iPad.

Portable entertainment device: this type of device can display and play multimedia contents, and includes: audio and video players (for example iPod), handheld game consoles, electronic books, intelligent toys and portable vehicle-mounted navigation devices.

A server: the server is a device for providing computing services, and includes a processor, a hard disk, an internal memory, a system bus, etc., and the server is similar to a general-purpose computer in architecture, but has relatively high requirements in the aspects of processing capacity, stability, reliability, safety, extendibility, manageability and the like due to the need of providing high-reliability services.

Other electronic devices with a data interaction function.

The device embodiment described above is only exemplary, the units illustrated as separate parts therein may be or not be physically separated, and the parts presented as units may be or not be physical units, that is to say, the parts may be positioned at one place, or distributed to a plurality of network units. Part or all of the modules therein may be selected according to actual needs to achieve the purpose of the scheme of the embodiment.

By virtue of the description of the embodiments mentioned above, those skilled in the art may clearly understand that each embodiment may be realized by virtue of software and a general hardware platform, and of course, may be realized by virtue of hardware. Based on such understanding, the technical scheme mentioned above substantially or the part making contribution to related technologies may be embodied in the form of a software product, and the computer software product may be stored in a computer readable storage medium, for example ROM/RAM, a diskette, a compact disk, etc., including a plurality of instructions for enabling one computer device (which may be a personal computer, a server, a network device or the like) to execute each embodiment or the method described by some parts of the embodiments.

Finally, it should be noted that: the embodiments mentioned above are only for illustrating rather than limiting the technical scheme of this application; although this application is described in detail with reference to the embodiments mentioned above, those of ordinary skill in the art still can modify the technical solution recorded by the embodiments mentioned above, or equivalently substitute part of the technical characteristics therein; and these modifications or substitutions do not make the essence of the corresponding technical scheme depart from the spirit and scope of the technical scheme of each embodiment of this application.

What is claimed is:

1. A method for obtaining a weight of articles executed by a terminal, the method comprising:
obtaining pressure information of an edge touch area of a terminal after an article is hung on the terminal; and
obtaining a weight of the article according to the pressure information of the edge touch area of the terminal.

2. The method according to claim 1, wherein the edge touch area of the terminal comprises an edge touch area of at least one side surface of the terminal.

3. The method according to claim 1, wherein a pressure sensor is set in the edge touch area of the terminal.

4. The method according to claim 3, wherein obtaining the weight of the article according to the pressure information of the edge touch area of the terminal comprises:
obtaining the weight of the article according to a conversion relationship between pressure and weight and the pressure information.

5. The method according to claim 1, wherein the method further comprises:
outputting the weight of the article.

6. A terminal, comprising:
at least one processor; and
a memory communicably connected with the at least one processor for storing instructions executable by the at least one processor, wherein execution of the instructions by the at least one processor causes the at least one processor to:
obtain pressure information of an edge touch area of a terminal after an article is hung on the terminal; and
obtain a weight of the article according to the pressure information of the edge touch area of the terminal.

7. The terminal according to claim 6, wherein the edge touch area of the terminal comprises an edge touch area of at least one side surface of the terminal.

8. The terminal according to claim 7, wherein a pressure sensor is set in the edge touch area of the terminal.

9. The terminal according to claim 8, wherein obtaining the weight of the article according to the pressure information of the edge touch area of the terminal comprises:
obtaining the weight of the article according to a conversion relationship between pressure and weight and the pressure information.

10. The terminal according to claim 7, wherein execution of the instructions by the at least one processor causes the at least one processor to:
output the weight of the article.

11. A non-transient computer readable storage medium that stores computer executable instructions, and the instructions are used for:
obtaining pressure information of an edge touch area of a terminal when an article is hung on the terminal; and
obtaining a weight of the article according to the pressure information of the edge touch area of the terminal.

12. The non-transient computer readable storage medium according to claim 11, wherein the edge touch area of the terminal comprises an edge touch area of at least one side surface of the terminal.

13. The non-transient computer readable storage medium according to claim 11, wherein a pressure sensor is set in the edge touch area of the terminal.

14. The non-transient computer readable storage medium according to claim 13, wherein obtaining the weight of the article according to the pressure information of the edge touch area of the terminal comprises:
obtaining the weight of the article according to a conversion relationship between pressure and weight and the pressure information.

15. The non-transient computer readable storage medium according to claim 11, wherein the instructions are executed by the at least one processor to enable the at least one processor to:
output the weight of the article.
